(19) United States
(12) Patent Application Publication
(10) Pub. No.: US 2019/0335059 A1
(43) Pub. Date: Oct. 31, 2019

(54) IMAGE READING APPARATUS

(71) Applicant: Toshiba Tec Kabushiki Kaisha, Tokyo (JP)

(72) Inventors: Naoyuki Misaka, Mishima Shizuoka (JP); Satomi Asaka, Yokohama Kanagawa (JP)

(73) Assignee: Toshiba Tec Kabushiki Kaisha, Tokyo (JP)

(21) Appl. No.: 15/962,593

(22) Filed: Apr. 25, 2018

(51) Int. Cl. H04N 1/401; H04N 1/409; H04N 1/193; H04N 1/00

(52) U.S. Cl. CPC H04N 1/401; H04N 1/4097; H04N 2201/0081; H04N 1/00045; H04N 1/1931

(57) ABSTRACT

An image reading apparatus includes a reader, a reference plate, a transportation mechanism, and a processor. The reader reads a line image in a main scanning direction. The transportation mechanism transports the reader in a sub-scanning direction. The processor reads a first number of line images across a first line width in the sub-scanning direction from the reference plate, on each block that results from division in the sub-scanning direction, which is performed by causing the reader to be transported using the transportation mechanism. Thus, the processor detects foreign matter on each block that is set to be on the reference plate, selects a reading block for reading shading data, from a block on which the foreign matter is not present, and reads the first number of line images, as the shading data, across a second line width that is narrower than the first line width.

### FIELD

Embodiments described herein relate generally to an image reading apparatus.

### BACKGROUND

An image reading apparatus is known to perform shading correction by reading a reference plate. This type of image reading apparatus divides the reference plate into a plurality of blocks of which each has its own prescribed width and specifies a block on which an unwanted material (foreign matter) is present. The image reading apparatus acquires shading data from a block other than a block on which an unwanted material is present.

The image reading apparatus sets a width of a line image that is to be read and a block that includes a plurality of line images, based on a reading technique, or the like. That is, the image reading apparatus sets a width of a block that varies according to the reading technique. As a result, the image reading apparatus needs to specify a block on which the unwanted material is present, among blocks of which each has its own width.

### DESCRIPTION OF THE DRAWINGS

FIG. 1 is a cross-sectional diagram illustrating an example of an image reading apparatus according to some embodiments.

FIG. 2 is a diagram illustrating an operational example of the image reading apparatus according to some embodiments.

FIG. 3 is a diagram illustrating an operational example of the image reading apparatus according to some embodiments.

### DETAILED DESCRIPTION

According to some embodiments, an image reading apparatus includes a reading mechanism (reader), a reference plate, a transportation mechanism, and a processor. The reading mechanism reads a line image in a main scanning direction. The transportation mechanism transports the reading mechanism in a sub-scanning direction. The processor reads a first number of line images across a first line width in the sub-scanning direction from the reference place, on every block that results from division in the sub-scanning direction, by causing the reading mechanism to be transported using the transportation mechanism. Thus, the processor detects foreign matter on every block that is set to be on the reference plate, selects a reading block for reading shading data, from a block on which the foreign matter is not present, and reads the first number of line images, as the shading data, across a second line width that is narrower than the first line width.

An embodiment will be described in detail below with reference to the drawings.

An image reading apparatus according to some embodiments reads an image from an original document that is placed on an original document stand. The image reading apparatus includes a contact image sensor (CIS) module for reading an image in the main scanning direction. The image reading apparatus causes the CIS module to move in the sub-scanning direction that intersects the main scanning direction, and reads an image of an entire original document.

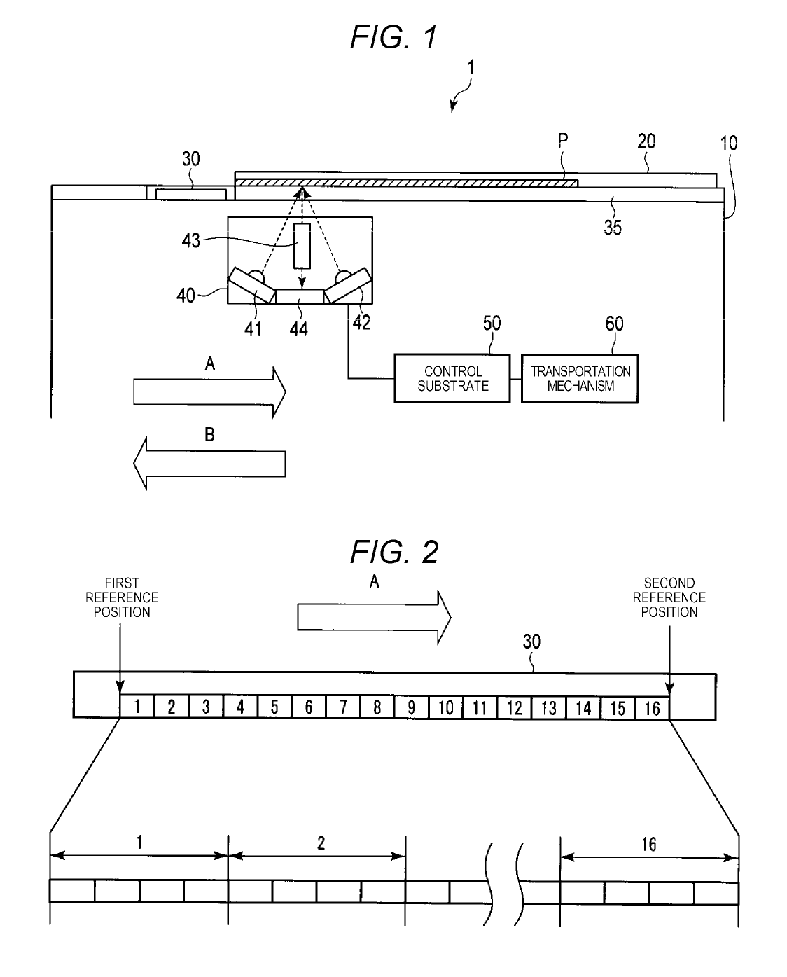

FIG. 1 is a cross-sectional diagram illustrating an image reading apparatus 1. The rightward direction in FIG. 1 is defined as an A direction, and a direction opposite to the A direction is defined as a B direction.

As illustrated in FIG. 1, the image reading apparatus 1 includes a case 10, an original document cover 20, a white reference plate 30, an original document stand glass pane 35, a CIS module 40, a control substrate 50, a transportation mechanism 60, and the like. The image reading apparatus 1 is assumed to be one that reads an image from an original document P.

The case 10 constitutes an outer covering of the image reading apparatus 1.

The original document cover 20 is formed on the case 10 and covers an original document 2. For example, a prescribed one end of the original document cover 20 is rotatably fixed to the case 10. The original document cover 20 exposes an original document 2 to the outside when the other end is lifted up.

The white reference plate 30 is a member for the CIS module 40 to acquire the shading data. For example, the white reference plate 30 may be a white plate that is formed to have a rectangular shape. The white reference plate 30 is formed in the main scanning direction in which the CIS module 40 reads an image. That is, the white reference plate 30 extends in a direction that is perpendicular to the page of FIG. 1. Furthermore, the white reference plate 30 has a width in the main scanning direction, which is greater than a width of the line image that is acquired by the CIS module 40 in the main scanning direction.

The original document stand glass pane 35 is formed from rectangular glass. The original document stand glass pane 35 is adjacent to the white reference plate 30. The original document P is placed on the original document stand glass pane 35. The original document stand glass pane 35 is greater than a maximum sized original document that is possibly read by the image reading apparatus 1. The original document stand glass pane 35 is formed in such a manner as to be built into the case 10. That is, the original document stand glass pane 35 transmits light from the original document P to the CIS module 40.

The contact image sensor (CIS) module 40 (the reading mechanism or reader) reads the original document P. The CIS module 40 extends in the main scanning direction, and acquires the line image in the main scanning direction. The CIS module 40 transmits the acquired line image to the control substrate 50.

The CIS module 40 is configured with a light source 41, a light source 42, a lens 43, a CCD sensor 44, and the like.

The light source 41 emits light that illuminates the white reference plate 30, the original document P, and the like. For example, the light source 41 is configured with a LED, a fluorescent lamp, or the like. The light source 41 is installed on one end of the bottom of the CIS module 40. The light source 41 emits light upward.

The light source 42 emits light that illuminates the white reference plate 30, the original document P, and the like. For example, the light source 42 may be configured with an LED, a fluorescent lamp, or the like. The light source 42 is installed on the other end of the bottom of the CIS module 40. The light source 42 emits light upward.

The lens 43 causes the light from the white reference plate 30 and the original document P to form an image on the CCD sensor 44. The lens 43 is formed on a center portion of the CIS module 40. The lens 43 causes the light from the white reference plate 30 and the original document P to forms an image just under the lens 43 itself.

The CCD sensor 44 converts the light from the lens 43 into a signal. The CCD sensor 44 is formed just under the lens 43. Furthermore, the CCD sensor 44 is formed between the light source 41 and the light source 42 in the bottom of the CIS module 40. For example, the CCD sensor 44 is configured with a plurality of photoelectric conversion elements that correspond to reading elements, respectively, in the main scanning direction. Each photoelectric conversion element of the CCD sensor 44 generates a signal in accordance with light intensity, and transmits the generated signal to the control substrate 50.

The transportation mechanism 60 causes the CIS module 40 to move in the A direction or the B direction based on a signal from the control substrate 50. The transportation mechanism 60 is configured with a control circuit, a motor, and the like.

The control circuit controls a drive system such as a motor. For example, the control circuit supplies a power, a pulse or the like to a drive system such as a motor, based on a signal from the control substrate 50.

The motor causes the CIS module 40 to move based on the power or the pulse from the control circuit. The motor establishes a connection to the CIS module 40 through a gear or a belt and causes the CIS module 40 to move.

The control substrate 50 controls the entire image reading apparatus 1. The control substrate 50 controls the light source 41, the light source 42, the CCD sensor 44, the transportation mechanism 60, and the like. The control substrate 50 performs an operation of reading the original document P according to an operation by an operator. Furthermore, the control substrate 50 acquires the shading data for shading correction.

For example, the control substrate 50 is configured with a processor or the like. A function that is to be implemented by the control substrate 50 is implemented by the processor executing a program that is stored in a memory. Furthermore, the control substrate 50 may be configured with a piece of hardware such as a processor, such as application specific integrated circuit (ASIC).

It is noted that the image reading apparatus 1 may employ a configuration according to need, other than a configuration that is illustrated in FIG. 1, and that the image reading apparatus 1 may exclude a specific configuration.

Next, an operational example of the image reading apparatus 1 will be described.

The operational example of the image reading apparatus 1 will be described based on an operational example of the control substrate 50.

First, an operational example of specifying the reading block from the control substrate 50 acquires the shading data will be described.

The control substrate 50 specifies the reading block according to the operation by the operator or the like. For example, the control substrate 50 specifies or updates the reading block at the time of shipping, at the time of replacement of the white reference plate 30, or the like.

FIG. 2 illustrates an operational example in which the control substrate 50 specifies the reading block.

In an example that is illustrated in FIG. 2, in an initial state, the CIS module 40 is assumed to be in a prescribed position more toward the B direction than the white reference plate 30. It is noted that the control substrate 50 may cause the CIS module 40 in another position to move to the prescribed position.

The control substrate 50 is divided into a plurality of blocks in the sub-scanning direction, on a portion of the white reference plate 30, which extends from a prescribed position (a “first reference position”) to a prescribed position (a “second reference position”). The control substrate 50 is divided into 16 blocks.

The blocks of the control substrate 50 are numbered 1 to 16 in the A direction, as block numbers that indicated blocks.

The control substrate 50 causes the CIS module 40 to move in the A direction at a prescribed speed. The control substrate 50 causes the CIS module 40 to pass under the white reference plate 30.

The control substrate 50 detects an unwanted material (foreign matter) that is present on the white reference plate 30, on a per-block basis, using the CIS module 40. That is, the control substrate 50 acquires an image in the main scanning direction and detects the unwanted material. The control substrate 50 may cause the light source 41 and the light source 42 to emit light. Furthermore, the control substrate 50 may cause the light source 41 and the light source 42 to emit light.

The control substrate 50 acquires four images (line images) on a per-block basis. For example, the control substrate 50 adjusts a frequency (a reading frequency) that determines a timing at which the line image is read by the CIS module 40, and a speed (a transportation speed) of the CIS module 40. That is, the control substrate 50 sets the reading frequency and the transportation speed, in such a manner that a distance (a line width) that the CIS module 40 moves in the sub-scanning direction while acquiring one line image is one fourth of a width of the block. The control substrate 50 sets a first width (the first line width) as the line width.

When the CIS module 40 is caused to move up to the “first reference position,” the control substrate 50 acquires a line image using the CIS module 40. For example, the control substrate 50 acquires one image (line image) from the CIS module 40 at a fixed interval.

While the CIS module 40 is caused to move up to the “second reference position,” the control substrate 50 acquires four line images on every block using the CIS module 40.

The control substrate 50 determines whether or not an unwanted material is present on a block based on the four line images. For example, when luminance of each of the four line images is at or below a prescribed threshold (an unwanted-material determination threshold), the control substrate 50 determines that the unwanted material is present on a block which corresponds to the line image. Furthermore, when average luminance of the four line images is at or below the unwanted-material determination threshold, the control substrate 50 determines that the unwanted material is present on the block that corresponds to the line image.

The control substrate 50 selects a block (a reading block) for acquiring the shading data from among blocks (valid blocks) that are determined as ones on which the unwanted material is not present. At this point, the control substrate 50 is assumed to need 32 line images as the shading data. Furthermore, even if the shading data is acquired, the control substrate 50 is assumed to acquire four line images from one block. Therefore, the control substrate 50 selects eight reading blocks from among valid blocks.

For example, the control substrate 50 selects the reading block, in a left-justified manner, from among the valid blocks. That is, the control substrate 50 may select the reading block from among the valid blocks, starting from the valid block that is closest to the “first reference position.”

Furthermore, the control substrate 50 may select the reading block, in a right-justified, from among the valid blocks. That is, the control substrate 50 may select the reading block from among the valid blocks, starting from the valid block that is closest to the “second reference position.”

Next, an operational example in which the control substrate 50 performs reading of the original document P on the original document stand glass pane 35 will be described. At this point, the operator is assumed to set the original document P to be on the original document stand glass pane 35.

The control substrate 50 starts to read the original document P on the original document stand glass pane 35 according to the operation by the operator or the like.

First, the control substrate 50 acquires the shading data from the white reference plate 30.

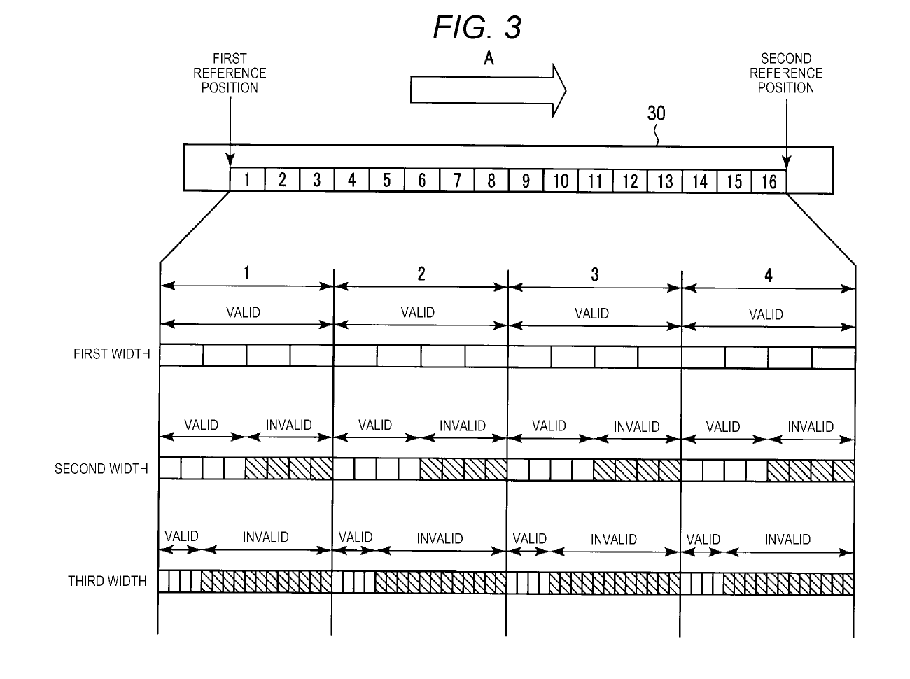

FIG. 3 illustrates an operational example in which the control substrate 50 acquires the shading data.

In an example that is illustrated in FIG. 3, in an initial state, the CIS module 40 is assumed to be in prescribed position more toward the B direction than the white reference plate 30. It is noted that the control substrate 50 may cause the CIS module 40 in another position to move to the prescribed position. Furthermore, the control substrate 50 is assumed to specify blocks that are indicated by “1” to “4,” respectively, as the reading blocks.

The control substrate 50 sets the line width according to the operation by the operator or the like. That is, the control substrate 50 sets the reading frequency and the transportation speed. For example, the control substrate 50 sets the line width based on whether color scan or monochromatic scan is available. Furthermore, the control substrate 50 sets the line width based on the resolution at which an image P is scanned.

The control substrate 50 is assumed to set a second width or a third width (a second line width) that is narrower than the first width. The second width is approximately half of the first width. Furthermore, the third width is approximately half of the second width.

The control substrate 50 acquires four line (a first number of) images, as the shading data, from each reading block. Based on the line width (at this point, the second width and the third width) and the width of the block, the control substrate 50 sets a valid line from which the line image is read, and an invalid line from which the line image is not read. The control substrate 50 sets the valid line and the invalid line in such a manner that four line images are acquired from each reading block.

The control substrate 50 sets a prescribed number (a second number) of invalid lines in such a manner that four valid lines fit into one reading block. That is, the control substrate 50 sets the invalid line in such a manner that a sum value that results from adding up widths of the valid lines and widths of the invalid lines is a width of the block.

As illustrated in FIG. 3, if the second width is set, the control substrate 50 sets four invalid lines after four valid lines. Because the second width is approximately half of the first width, by adding four invalid lines, the control substrate 50 causes four valid lines to be included in one reading block.

As illustrated in FIG. 3, if the third width is set, the control substrate 50 sets 12 invalid lines after four valid lines. Because the third width is approximately one fourth of the first width, by adding 12 invalid lines, the control substrate 50 causes four valid lines to be included in one reading block.

It is noted that the control substrate 50 may set the invalid lines in such a manner that the sum value that results from adding up the widths of the valid lines and the widths of the invalid lines exceeds the width of the block. In this case, the control substrate 50 sets the invalid line in such a manner that a difference between the sum value and the width of the block is smaller than the line width.

The control substrate 50 sets the invalid line after the valid line. It is noted that the control substrate 50 may set the invalid line before the valid line within the reading block. Furthermore, the control substrate 50 may set the valid line and the invalid line alternately. A position in which the invalid line is set is not limited to a specific constitution.

The control substrate 50 acquires the shading data along the valid line and the invalid line that are set.

That is, the control substrate 50 acquires the shading data from the valid line while causing the CIS module 40 to move in the A direction.

The control substrate 50 causes the CIS module 40, as is, to move in the A direction. The control substrate 50 causes the CIS module 40 to move up to an end edge of the original document P or an end edge of the original document stand glass pane 35. The control substrate 50 acquires the line image of the original document P while continuing to cause the CIS module 40 to move in the A direction.

When acquiring the image of the original document P, the control substrate 50 performs the shading correction based on the shading data. Because image data is acquired with uniform brightness, the shading correction is to correct luminance irregularity that occurs due to characteristic of an optical system or the like. For example, the control substrate 50 adjusts luminance of an image in each position in the main scanning direction based on the shading data.

It is noted that the control substrate 50 may perform the shading correction further based on shading data in compliance with a black reference. For example, the control substrate 50 acquires the line image in a state where the light source 41 and the light source 42 are switched off, and acquires the shading data in compliance with the black reference. Furthermore, the control substrate 50 may read a black reference plate and may acquire the shading data in compliance with the black reference.

The control substrate 50 generates an image of the original document from the line image that is read. The control substrate 50 stores the generated image in a prescribed memory or transmits the generated image to an external apparatus.

It is noted that because the unwanted-material determination threshold is acquired, the control substrate 50 may acquire the line image from the white reference plate 30 using the CIS module 40. For example, the control substrate 50 causes the CIS module 40 to move from the “first reference position” up to the “second reference position” and acquires the line image between the two positions.

Furthermore, the control substrate 50 may set the reading block of the black reference plate. The control substrate 50 may read the shading data from the reading block.

Furthermore, the image reading apparatus 1 may include a printer that prints the acquired image.

An image reading apparatus that is configured in this manner detects the unwanted material of every block that is set to be on the white reference plate. The image formation apparatus acquires the line image across a prescribed line width and detects an unwanted material on every block. The image reading apparatus acquires the shading data from the reading block on which the unwanted material is not present.

If the shading data is acquired across another line width, the image reading apparatus sets the number of invalid lines that is based on the number of valid lines which are necessary for the reading block and on the line width. As a result, the image reading apparatus can suitably set the number of the valid lines that are necessary for each reading block. Therefore, even if another line width is set, the image reading apparatus can acquire the shading data from the reading block.

In the related art, the image reading apparatus forms a second block across another line width and reads the shading data. In this case, the image reading apparatus cannot select the second block that overlaps the block on which the unwanted material is present, as a block for reading the shading data. For this reason, there is a concern that the number of selectable second blocks will be small in the image reading apparatus.

Even if another line width is set, the image reading apparatus according to the embodiment reads the shading data from the same reading block. For this reason, in the image reading apparatus, there is not concern described above.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image reading apparatus comprising:
a reader configured to read a line image in a main scanning direction;
a reference plate;
a transportation mechanism configured to transport the reader in a sub-scanning direction; and
a processor configured:
to read a first number of line images across a first line width in the sub-scanning direction from the reference plate, on each block that results from division in the sub-scanning direction, by causing the reader to be transported using the transportation mechanism to thereby detect foreign matter on each block that is set to be on the reference plate,
to select a reading block for reading shading data, from a block on which the foreign matter is not present, and
to read the first number of line images, as the shading data, across a second line width that is narrower than the first line width.

2. The apparatus according to claim 1,
wherein the processor is configured to set a first number of valid lines, and a second number of invalid lines that is based on the second line width, and to read the shading data along the valid lines and the invalid lines.

3. The apparatus according to claim 2,
wherein the processor is configured to set the first number of the valid lines and the second number of the invalid lines on each reading block, and to set the second number of the invalid lines in such a manner that a sum value of widths of the valid lines and widths of the invalid lines is a width of the block.

4. The apparatus according to claim 3,
wherein the processor is configured to set the second number of the invalid lines in such a manner that a difference between the sum value and the width of the block is smaller than the second line width.

5. The apparatus according to claim 2,
wherein the processor is configured to set the invalid lines after the valid lines.

6. The apparatus according to claim 2,
wherein the processor is configured to set the invalid lines before the valid lines.

7. The apparatus according to claim 1,
wherein the reference plate is white.

8. The apparatus according to claim 1,
wherein the reference plate is black.

9. The apparatus according to claim 1,
wherein the reader includes a CCD sensor.

10. The apparatus according to claim 1, wherein the processor is configured to determine that foreign matter exists on a block based on luminance of a respective one of the line images being below a threshold.

11. The apparatus according to claim 1, wherein the processor is configured to set a line width based on a resolution at which an image is set to be read.

12. The apparatus according to claim 1, wherein the processor is configured to set a line width based on whether an image is set to be read in monochrome or color.

13. The apparatus according to claim 1, wherein the processor is configured to perform shading correction based on the shading data.

14. The apparatus according to claim 13, wherein the shading correction includes adjusting the luminance of the image.

15. A method of operating an image reading apparatus including a reader configured to read a line image in a main scanning direction and a reference plate, the method comprising:
reading a first number of line images across a first line width in a sub-scanning direction from the reference plate, on each block that results from division in the sub-scanning direction, by causing the reader to be transported to thereby detect foreign matter on each block that is set to be on the reference plate;
selecting a reading block for reading shading data, from a block on which the foreign matter is not present, and
reading the first number of line images, as the shading data, across a second line width that is narrower than the first line width.

16. The method according to claim 15, further comprising setting a first number of valid lines, and a second number of invalid lines that is based on the second line width, and reading the shading data along the valid lines and the invalid lines.

17. The method according to claim 16,
wherein the first number of the valid lines and the second number of the invalid lines on each reading block are set, and the second number of the invalid lines are set in such a manner that a sum value of widths of the valid lines and widths of the invalid lines is a width of the block.

18. The method according to claim 17,
wherein the second number of the invalid lines is set in such a manner that a difference between the sum value and the width of the block is smaller than the second line width.

19. The method according to claim 16,
wherein the invalid lines are set after the valid lines.

20. The method according to claim 15, wherein the foreign matter is determined to exist on a block based on luminance of a respective one of the line images being below a threshold.
